(19) United States
(12) Patent Application Publication
(10) Pub. No.: US 2017/0323140 A1
(43) Pub. Date: Nov. 9, 2017

(54) OPTICAL SENSING MODULE AND FINGERPRINT SENSING DEVICE

(71) Applicant: EOSMEM CORPORATION, Hsinchu County (TW)

(72) Inventors: Yu-Hsiang Huang, Hsinchu County (TW); Chun-Yi Lu, Hsinchu County (TW); Hui-Min Tsai, Hsinchu County (TW)

(73) Assignee: EOSMEM CORPORATION, Hsinchu County (TW)

(21) Appl. No.: 15/587,406

(22) Filed: May 5, 2017

Related U.S. Application Data
(60) Provisional application No. 62/332,491, filed on May 6, 2016.

(30) Foreign Application Priority Data
Dec. 1, 2016 (TW) 105139758

(51) Int. Cl. G06K 9/00

(52) U.S. Cl. CPC G06K 9/0004; G06K 9/0008

(57) ABSTRACT

An optical sensing module is configured to sense a fingerprint of a finger. The optical sensing module includes an image sensor, a light transmissive layer, and an image selecting layer. The light transmissive layer is disposed on the image sensor, and the image selecting layer is disposed on the light transmissive layer. When the finger touches a side of the optical sensing module adjacent to the image selecting layer, air in valleys of the fingerprint contacts the optical sensing module, so that the image selecting layer has a first transmittance for light from the valleys; ridge of the fingerprint contact the optical sensing module, so that the image selecting layer has a second transmittance for light from the ridges. The first transmittance is not equal to the second transmittance. A fingerprint sensing device is also provided.

### CROSS-REFERENCE TO RELATED APPLICATION

This application claims the priority benefits of U.S. provisional application Ser. No. 62/332,491, filed on May 6, 2016 and Taiwan application serial no. 105139758, filed on Dec. 1, 2016. The entirety of each of the above-mentioned patent applications is hereby incorporated by reference herein and made a part of this specification.

### FIELD OF THE INVENTION

The invention relates to an optical module and more particularly relates to an optical sensing module and a fingerprint sensing device.

### DESCRIPTION OF RELATED ART

Biometric systems are gradually applied in daily lives, and fingerprints are one of the most convenient ways for authentication. Optical fingerprint sensing devices and capacitive fingerprint sensing devices are the two common fingerprint sensing devices. In an optical fingerprint sensing device, a fingerprint is irradiated by a light source, and the image generated by the light reflected from the fingerprint is captured by an image sensor, so as to obtain the image of the fingerprint.

The fingerprint of a finger has depressions (referred to as “valleys” hereinafter) and peaking portions (referred to as “ridge” hereinafter), and lights emitted from the light source are reflected to the image sensor by the valleys as well as by the ridges. Existing optical fingerprint sensing devices are unable to distinguish the light from the valleys from the light from the ridges; as a result, the two types of lights are both reflected to the image sensor to generate the image of the fingerprint. Nevertheless, in the image of the fingerprint, the contrast between the valleys and the ridges is relatively low, thus leading to increasing difficulties in fingerprint recognition as a result.

### SUMMARY OF THE INVENTION

The invention provides an optical sensing module for obtaining a fingerprint image with a high contrast.

The invention provides a fingerprint sensing device for obtaining a fingerprint image with a high contrast.

In an embodiment of the invention, an optical sensing module is provided for sensing a fingerprint of a finger. The optical sensing module includes an image sensor, a light transmissive layer, and an image selecting layer. The light transmissive layer is disposed on the image sensor, and the image selecting layer is disposed on the light transmissive layer. When the finger touches a side of the optical sensing module adjacent to the image selecting layer, air in valleys of the fingerprint contacts the optical sensing module, so that the image selecting layer has a first transmittance for light from the valleys, and ridges of the fingerprint contact the optical sensing module, so that the image selecting layer has a second transmittance for light from the ridges. The first transmittance is not equal to the second transmittance, such that one of the light from the valleys and the light from the ridges of the fingerprint is transmitted to the image sensor, and the image selecting layer reflects the other of the light from the valleys and the light from the ridges of the fingerprint to a direction away from the image sensor.

In an embodiment of the invention, a fingerprint sensing device is provided for sensing a fingerprint of a finger. The fingerprint sensing device includes a light emitting element and the aforementioned optical sensing module. A detection light irradiating the fingerprint is emitted by the light emitting element. When the finger touches a side of the optical sensing module adjacent to the image selecting layer, air in valleys of the fingerprint contacts the optical sensing module, so that the image selecting layer has a first transmittance for light from the valleys, and ridges of the fingerprint contact the optical sensing module, so that the image selecting layer has a second transmittance for light from the ridges. The first transmittance is not equal to the second transmittance, such that one of the detection light from the valleys and the detection light from the ridges of the fingerprint is transmitted to the image sensor, and the image selecting layer reflects the other of the detection light from the valleys and the detection light from the ridges of the fingerprint to a direction away from the image sensor.

In the optical sensing module and the fingerprint sensing device in an embodiment of the invention, when the finger touches one side of the optical sensing module adjacent to the image selecting layer, the air in the valleys of the fingerprint contacts the optical sensing module, so that the image selecting layer has the first transmittance for the light from the valleys, and the ridges of the fingerprint contact the optical sensing module, so that the image selecting layer has the second transmittance for the light from the ridges. The first transmittance is not equal to the second transmittance, such that one of the light from the valleys and the light from the ridges of the fingerprint is transmitted to the image sensor, and the image selecting layer reflects the other of the light from the valleys and the light from the ridges of the fingerprint to a direction away from the image sensor. Therefore, the contrast between the ridges and the valleys in the fingerprint image obtained by the image sensor is larger; in other words, the image sensor is able to acquire the fingerprint image with a high contrast.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a fingerprint sensing device according to an embodiment of the invention.

FIG. 2 is a brief schematic view illustrating a principle of the optical sensing module in FIG. 1.

FIG. 3 is a schematic enlarged view illustrating a principle of the optical sensing module in FIG. 1.

FIG. 4 is a schematic view illustrating a detailed structure of the image selecting layer in FIG. 1.

FIG. 5A is a schematic cross-sectional view illustrating an optical sensing module according to another embodiment of the invention.

FIG. 5B is a schematic cross-sectional view illustrating a detailed structure of the image selecting layer in FIG. 5A.

FIG. 6 is a diagram comparing among a light emitting spectrum of a light emitting element in the fingerprint sensing device in FIG. 1, a transmission spectrum of the image selecting layer when being touched by ridges of a fingerprint, and a transmission spectrum of the image selecting layer when being touched by air.

### DESCRIPTION OF THE EMBODIMENTS

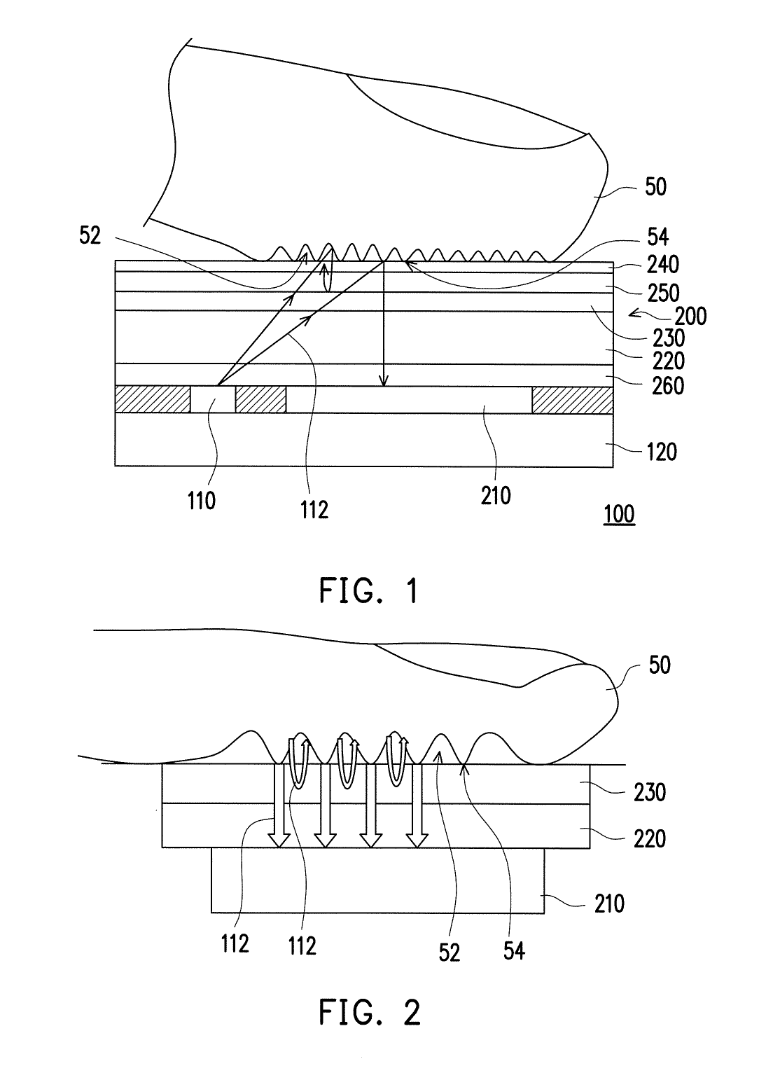

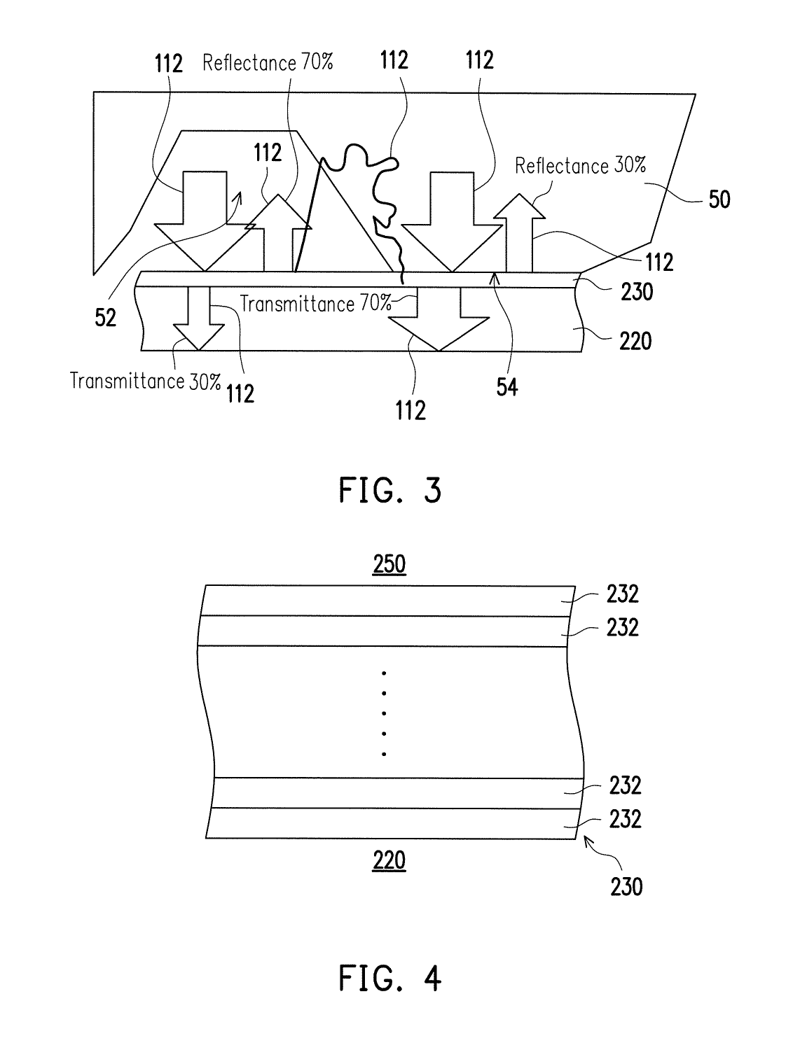

FIG. 1 is a schematic cross-sectional view of a fingerprint sensing device according to an embodiment of the invention, FIG. 2 is a brief schematic diagram illustrating a principle of the optical sensing module in FIG. 1. FIG. 3 is a schematic enlarged view illustrating a principle of the optical sensing module in FIG. 1, FIG. 4 is a schematic cross-sectional view illustrating a detailed structure of the image selecting layer in FIG. 1. Referring to FIG. 1 to FIG. 4, a fingerprint sensing device 100 provided in the embodiment is configured to sense a fingerprint of a finger 50 and includes a light emitting element 110 and an optical sensing module 200. The light emitting element 110 is configured to emit a detection light 112 irradiating the fingerprint. In the embodiment, the light emitting element 110 is, for example, a light emitting diode (LED). However, in other embodiments, the light emitting element 110 may also be a laser diode or other suitable light emitting elements. In the embodiment, the detection light 112 is, for example, an infrared light, while in other embodiments the detection light 112 may also be a visible light or an invisible light with a different wave band.

The optical sensing module 200 includes an image sensor 210, a light transmissive layer 220, and an image selecting layer 230. The light transmissive layer 220 is disposed on the image sensor 210, and the image selecting layer 230 is disposed on the light transmissive layer 220. In the embodiment, the image sensor 210 is, for example, a charge coupled device (CCD) or a complementary metal oxide semiconductor (CMOS) image sensing device, and a material of the light transmissive layer 220 may include, for example, glass with a refractive index of, for example, approximately 1.5.

When the finger 50 touches a side of the optical sensing module 200 adjacent to the image selecting layer 230, air in valleys 52 of the fingerprint contacts the optical sensing module 200, so that the image selecting layer 230 has a first transmittance for the detection light 112 from the valleys 52, and ridges 54 of the fingerprint contact the optical sensing module 200, so that the image selecting layer 230 has a second transmittance for the detection light 112 from the ridges 54. The first transmittance is not equal to the second transmittance, such that one of the detection light 112 from the valleys 52 and the detection light 112 from the ridges 54 of the fingerprint is transmitted to the image sensor 210, and the image selecting layer 230 reflects the other of the detection light 112 from the valleys 52 and the detection light 112 from the ridges 54 of the fingerprint to a direction away from the image sensor 21 to irradiate the fingerprint again. Thereby, the detection light may be recycled and re-used. As such, the contrast between the ridges 54 and the valleys 52 in the fingerprint image obtained by the image sensor 210 is larger; in other words, the image sensor 210 is able to obtain the fingerprint image with a high contrast. In the embodiment, the ridges 54 refer to protruding patterns in the fingerprint, and the valleys 52 refer to grooves between adjacent ridges in the fingerprint.

In the embodiment, the detection light 112 from the ridges 54 penetrates the image selecting layer 230 and is transmitted to the image sensor 210, and the image selecting layer 230 reflects the detection light 112 from the valleys 52 to a direction away from the image sensor 210, meaning that the second transmittance is greater than the first transmittance. Meanwhile, a first reflectance of the image selecting layer 230 for the detection light 112 from the valleys 52 is, for example, greater than a second reflectance of the image selecting layer 230 for the detection light 112 from the ridges 54 as shown in FIG. 3. However, in other embodiments, it may also be the detection light 112 from the valleys 52 to penetrate the image selecting layer 230 and to be transmitted to the image sensor 210, and the image selecting layer 230 reflects the detection light 112 from the ridges 54 to a direction away from the image sensor 210, meaning that the first transmittance is greater than the second transmittance. At this time, the first reflectance of the image selecting layer 230 for the detection light 112 from the valleys 52 is, for example, smaller than the second reflectance of the image selecting layer 230 for the detection light 112 from the ridges 54.

In the embodiment, the image selecting layer 210 is, for example, a multilayer film with a plurality of stacked sub-films 232, and refractive indexes of the sub-films 232 appear alternately high and low along a stacking direction of the sub-films. Since a refractive index of the air in the valleys 52 is approximately 1, and a refractive index of the ridges 54 is approximately 1.4, the design of the refractive indexes and thicknesses of the sub-films 232 allows the detection light 112 from the valleys 52 and the detection light 112 from the ridges 54 to generate different thin-film interference effects. For example, a constructive interference and a destructive interference are respectively generated under and above the image selecting layer 210 by one of the two detection lights 112, and thereby the detection light 112 tends to penetrate the image selecting layer 210 and is prone to be transmitted to the image sensor 210. In addition, the destructive interference and the constructive interference are respectively generated under and above e the image selecting layer 210 by the other detection light 112, and the detection light 112 tends to be reflected back to the finger 50 by the image selecting layer 210. In the embodiment, one of the sub-films 232 most distant from the image sensor 210 (i.e., closest to the finger 50) has a refractive index greater than or equal to 1.5, and a material of the sub-films 232 of the image selecting layer 210 is, for example, silicon dioxide (SiO₂), tantalum dioxide (TaO₂), etc. According to the design of different refractive indexes and thicknesses of the sub-films 232, it is determined which side of the image selecting layer 210 the constructive interference and the destructive interference occur, and whether the second transmittance is greater than the first transmittance or the first transmittance is greater than the second transmittance. As such, it can be further determined whether bright lines of the fingerprint image should correspond to the ridges 54 or correspond to the valleys 52.

In the embodiment, a difference value between the first transmittance and the second transmittance is greater than or equal to 10%, so that an image contrast between the ridges 54 and the valleys 52 is effectively enhanced. According to the present embodiment, the image sensing module 200 further includes a functional layer 240 disposed on the image selecting layer 210. The functional layer 240 is, for example, an anti-smudge layer. However, in other embodiments, the functional layer 240 may also be a scratch-resistant layer, a waterproof layer, or any other functional film layer. In addition, in the embodiment, the image sensing module 200 further includes a hard coating layer 250 disposed on the image selecting layer 210 and between the functional layer 240 and the image selecting layer 210. In the embodiment, a pencil hardness (grade of pencil) of the hard coating layer 250 is greater than or equal to 9H. In addition, a material of the hard coating layer 250 is, for example, aluminum oxide (e.g., sapphire) or silicon nitride.

In the embodiment, the image selecting layer 210 may be colored, such as gold, rose gold, silver, or other colors due to the design of different thicknesses and refractive indexes of the multilayer sub-films 232. Nevertheless, in other embodiments, the image selecting layer 210 may also be colorless (i.e., the image selecting layer 210 may have no color). In addition, the light transmissive layer 220 in the embodiment may be adhered to the image sensor 210 by an optical clear resin (OCR). Alternatively, in another embodiment, the OCR may be replaced with an optical clear adhesive (OCA).

In the embodiment, the fingerprint sensing device 100 may include a substrate 120 that holds the light emitting element 110 and the image sensor 210. The substrate 120 is, for example, a circuit board, and is electrically connected to the light emitting element 110 and the image sensor 210. However, in another embodiment, the substrate 120 may also be any other suitable carrier board.

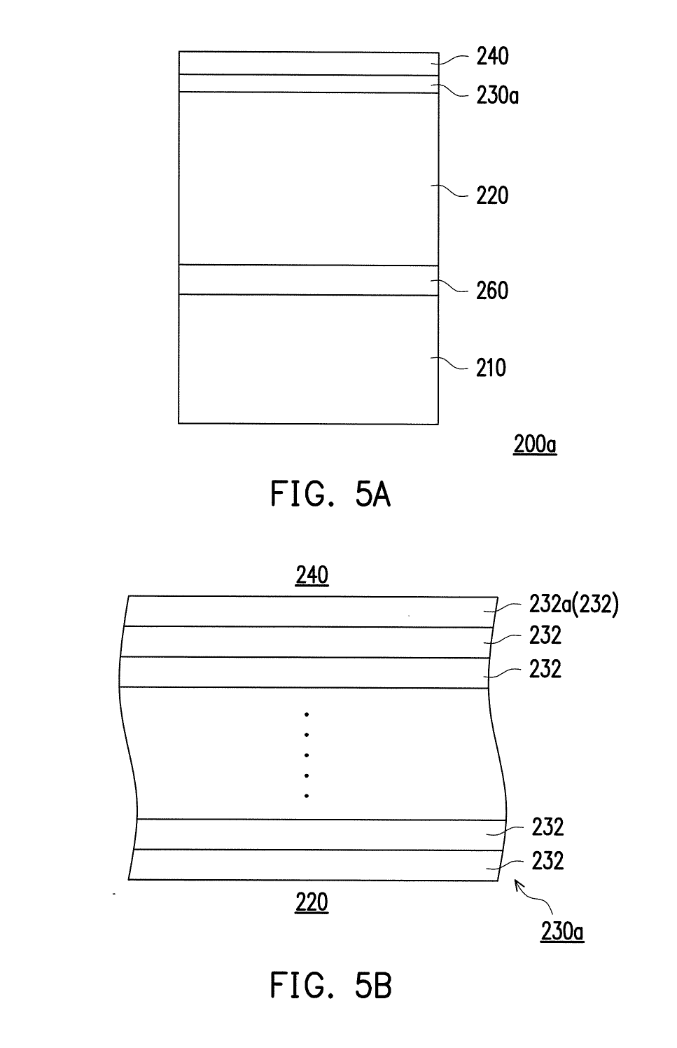

FIG. 5A is a schematic cross-sectional view illustrating an optical sensing module according to another embodiment of the invention, and FIG. 5B is a schematic cross-sectional view illustrating a detailed structure of the image selecting layer in FIG. 5A. Referring to FIG. 5A and FIG. 5B, an optical sensing module 200a provided in the embodiment is similar to the optical sensing module 200 in FIG. 1, and the differences between the two optical sensing modules are described as follows. In the optical sensing module 200a provided in the embodiment, among the sub-films 232 of an image selecting layer 230a, one of the sub-films 232a most distant from the image sensor 210 is a hard coating layer with a refractive index greater than or equal to 1.6, and the sub-film 232a is made of, for example, aluminum oxide (e.g., sapphire) or silicon nitride. The pencil hardness of the sub-film 232a is, for example, greater than or equal to 9H. Therefore, in the embodiment, no other hard coating layer is required to be disposed between the image selecting layer 230a and the functional layer 240.

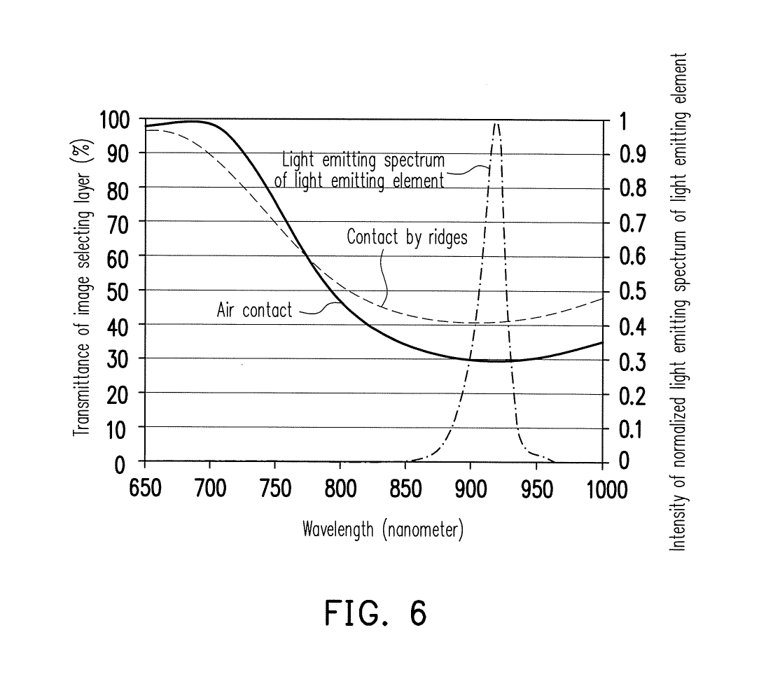

FIG. 6 is a diagram comparing among a light emitting spectrum of a light emitting element in the fingerprint sensing device in FIG. 1, a transmission spectrum of the image selecting layer when being touched by ridges of a fingerprint, and a transmission spectrum of the image selecting layer when being touched by air. Please refer to FIG. 1 and FIG. 6. In FIG. 6, within a range of light emitting wavelengths of the light emitting element 110, if the optical sensing module 200 is touched by the ridges 54 and the air in the valleys 52, the difference value between the transmittances of the image selecting layer 230 is approximately 10% under the two circumstances, which can thus prove that a fingerprint image with a higher contrast is obtained by the fingerprint sensing device 100 and the optical sensing module 200 in the embodiment. Therefore, the accuracy and the success rate of fingerprint recognition may be effectively enhanced.

In view of the foregoing, in the optical sensing module and the fingerprint sensing device provided in the embodiments of the invention, when the finger touches one side of the optical sensing module adjacent to the image selecting layer, the air in the valleys of the fingerprint contacts the optical sensing module, so that the image selecting layer has the first transmittance for the light from the valleys, and the ridges of the fingerprint contact the optical sensing module, so that the image selecting layer has the second transmittance for the light from the ridges. The first transmittance is not equal to the second transmittance, such that one of the light from the valleys and the light from the ridges of the fingerprint is transmitted to the image sensor, and the image selecting layer reflects the other of the light from the valleys and the light from the ridges of the fingerprint to a direction away from the image sensor. Therefore, the contrast between the ridges and the valleys in the fingerprint image obtained by the image sensor is larger; in other words, the image sensor provided herein is able to obtain the fingerprint image with the high contrast.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. An optical sensing module, configured to sense a fingerprint of a finger and comprising:
an image sensor;
a light transmissive layer, disposed on the image sensor; and
an image selecting layer, disposed on the light transmissive layer,
wherein when the finger touches a side of the optical sensing module adjacent to the image selecting layer, air in valleys of the fingerprint contacts the optical sensing module, such that the image selecting layer has a first transmittance for light from the valleys, ridges of the fingerprint contact the optical sensing module, such that the image selecting layer has a second transmittance for light from the ridges, the first transmittance is not equal to the second transmittance, such that one of the light from the valleys and the light from the ridges of the fingerprint is transmitted to the image sensor, and the image selecting layer reflects the other of the light from the valleys and the light from the ridges of the fingerprint to a direction away from the image sensor.

2. The optical sensing module as claimed in claim 1, wherein the image selecting layer has a plurality of stacked sub-films, refractive indexes of the sub-films appear alternately high and low along a stacking direction of the sub-films, and the refractive index of one of the sub-films most distant from the image sensor is greater than or equal to 1.5.

3. The optical sensing module as claimed in claim 1, wherein the image selecting layer is colored.

4. The optical sensing module as claimed in claim 1, wherein a difference value between the first transmittance and the second transmittance is greater than or equal to 10%.

5. The optical sensing module as claimed in claim 1, further comprising a functional layer disposed on the image selecting layer.

6. The optical sensing module as claimed in claim 1, further comprising a hard coating layer disposed on the image selecting layer.

7. The optical sensing module as claimed in claim 6, wherein a pencil hardness of the hard coating layer is greater than or equal to 9H.

8. The optical sensing module as claimed in claim 1, wherein the image selecting layer has a plurality of stacked sub-films, and one of the sub-films most distant from the image sensor is a hard coating layer.

9. The optical sensing module as claimed in claim 1, wherein the image sensor is a charge coupled device or a complementary metal oxide semiconductor image sensing device.

10. The optical sensing module as claimed in claim 1, wherein a material of the light transmissive layer comprises glass.

11. A fingerprint sensing device, configured to sense a fingerprint of a finger and comprising:
a light emitting element, configured to emit a detection light irradiating the fingerprint; and
an optical sensing module, comprising:
an image sensor;
a light transmissive layer, disposed on the image sensor; and
an image selecting layer, disposed on the light transmissive layer,
wherein when the finger touches a side of the optical sensing module adjacent to the image selecting layer, air in valleys of the fingerprint contacts the optical sensing module, such that the image selecting layer has a first transmittance for the detection light from the valleys, ridges of the fingerprint contact the optical sensing module, such that the image selecting layer has a second transmittance for the detection light from the ridges, the first transmittance is not equal to the second transmittance, such that one of the detection light from the valleys and the detection light from the ridges of the fingerprint is transmitted to the image sensor, and the image selecting layer reflects the other of the detection light from the valleys and the detection light from the ridges of the fingerprint to a direction away from the image sensor.

12. The fingerprint sensing device as claimed in claim 11, wherein the image selecting layer has a plurality of stacked sub-films, refractive indexes of the sub-films appear alternately high and low along a stacking direction of the sub-films, and the refractive index of one of the sub-films most distant from the image sensor is greater than or equal to 1.5.

13. The fingerprint sensing device as claimed in claim 11, wherein the image selecting layer is colored.

14. The fingerprint sensing device as claimed in claim 11, wherein a difference value between the first transmittance and the second transmittance is greater than or equal to 10%.

15. The fingerprint sensing device as claimed in claim 11, wherein the optical sensing module further comprises a functional layer disposed on the image selecting layer.

16. The fingerprint sensing device as claimed in claim 11, wherein the optical sensing module further comprises a hard coating layer disposed on the image selecting layer.

17. The fingerprint sensing module as claimed in claim 16, wherein a pencil hardness of the hard coating layer is greater than or equal to 9H.

18. The fingerprint sensing module as claimed in claim 11, wherein the image selecting layer has a plurality of stacked sub-films, and one of the sub-films most distant from the image sensor is a hard coating layer.

19. The fingerprint sensing module as claimed in claim 11, wherein the image sensor is a charge coupled device or a complementary metal oxide semiconductor image sensing device.

20. The fingerprint sensing module as claimed in claim 11, wherein a material of the light transmissive layer comprises glass.
